(19) United States
(12) Patent Application Publication
(10) Pub. No.: US 2017/0210272 A1
(43) Pub. Date: Jul. 27, 2017

(54) CAMPING CAR HAVING ELECTRIC BED FRAME

(71) Applicant: Chuan-Hang SHIH, Lu-Kang Town (TW)

(72) Inventor: Chuan-Hang SHIH, Lu-Kang Town (TW)

(21) Appl. No.: 15/204,178

(22) Filed: Jul. 7, 2016

Related U.S. Application Data
(63) Continuation-in-part of application No. 15/065,482, filed on Mar. 9, 2016.

(30) Foreign Application Priority Data
Jan. 21, 2016 (TW) 105200899

(51) Int. Cl. B60P 3/39; A47C 20/04; A47C 17/80

(52) U.S. Cl. CPC B60P 3/39; A47C 17/80; A47C 20/041

(57) ABSTRACT

A camping car includes a car body and an electric bed frame. The electric bed frame is disposed inside the car body. As a result, user can use the electric bed frame inside the camping car, so as to enhance comfortableness and convenience.

### CROSS REFERENCE TO RELATED APPLICATION

This application is a Continuation-In-Part of co-pending application Ser. No. 15/065,482, filed on 9 Mar. 2016, and this application claims priority of Application No. 105200899, filed in TAIWAN on 21 Jan. 2016, the entire contents of which are hereby incorporated by reference.

### BACKGROUND OF THE INVENTION

1. Field of the Invention

The present invention relates generally to vehicles and more particularly, to a camping car having an electric bed frame.

2. Description of the Related Art

The camping is one of popular outdoor activities in many countries. Staying in the nature for a couple days would help people to ease pressure and get relax. In order to stay overnight in the nature, some people may pitch tents for sleeping inside. However, a camping car is more convenient than the tent to be a shelter. Some of the camping cars may include at least a toilet, a kitchen, a living room, and, of course, a bed. Each of these camping cars are just like a movable house. A user merely need to plug in power and water, and the camping car can provide many functions provided by a normal house.

In general, a traditional bed would be disposed inside of the camping car. However, the traditional bed of the camping car is less functional and may not meet a requirement of high-quality and restful sleep or rest. Accordingly, the traditional bed of the camping car shall be improved.

### SUMMARY OF THE INVENTION

The present invention has been accomplished in view of the above-noted circumstances. It is an objective of the present invention to provide a camping car having an electric bed frame, so that users can enjoy a comfortable and convenient electric bed inside the camping car.

To attain the above objective, the present invention provides a camping car which includes a car body and an electric bed frame disposed inside the car body.

Because the electric bed frame has a function for lifting a specific body portion such as the back, the legs, and etc., the body would be in a better rest posture according to demand of user. Therefore, the camping car having the electric bed frame can make users feel more comfortable when they rest in the camping car.

### BRIEF DESCRIPTION OF THE DRAWINGS

FIG. 1 is a perspective view of a camping car according to a preferred embodiment of the present invention, showing that a bed platform and an electric bed frame inside the camping car.

FIG. 2 is a perspective view of the electric bed frame according to a preferred embodiment of the present invention.

FIG. 3 is a sectional view of a part of the electric bed frame according to the preferred embodiment of the present invention.

FIG. 4 is a bottom view of the electric bed frame according to the preferred embodiment of the present invention.

FIG. 5 is an enlarged view of a part of the electric bed frame according to the preferred embodiment of the present invention, showing a corner plate, through holes, and screw locking members.

FIG. 6 is another perspective view of the electric bed frame according to the preferred embodiment of the present invention, showing the function of the electric bed frame.

### DETAILED DESCRIPTION OF THE INVENTION

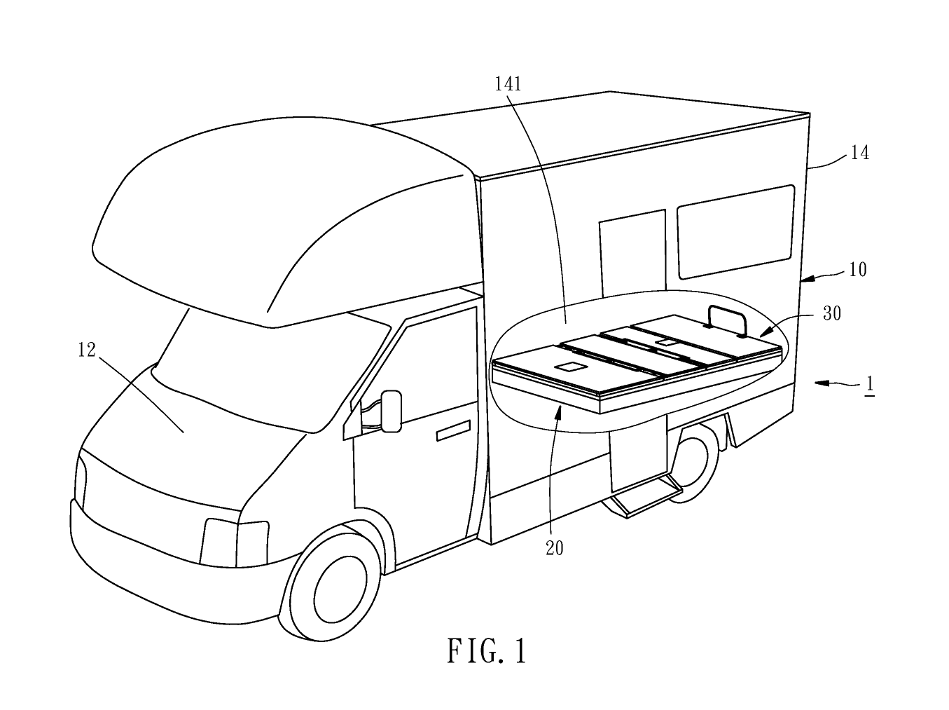

Referring to FIG. 1, a camping car 1 according to a preferred embodiment of the present invention includes a car body 10, a bed platform 20, and an electric bed 30. The camping car 1 may be called as a motorhome, a caravan, or a recreational vehicle (RV), etc. according to its size, structure, and functions.

The straight driving direction of the camping car 1 is defined as the front direction. The car body 10 includes a cab 12 and a car cabin 14 extended upwardly from the top of the cab 12 and backwardly from the rear of cab 12 respectively. It should be noticed that, in other embodiments, the car cabin 14 may be a travel trunk hung at the rear of the camping car 1.

The bed platform 20 and the electric bed frame 30 disposed on the top of the bed platform 20 are disposed at an inside 141 of the car cabin 14.

The bed platform 20 can be a base plate protruding upwardly from a floor of the car cabin 14, a base rack, an original bed frame or bed of user, and etc.

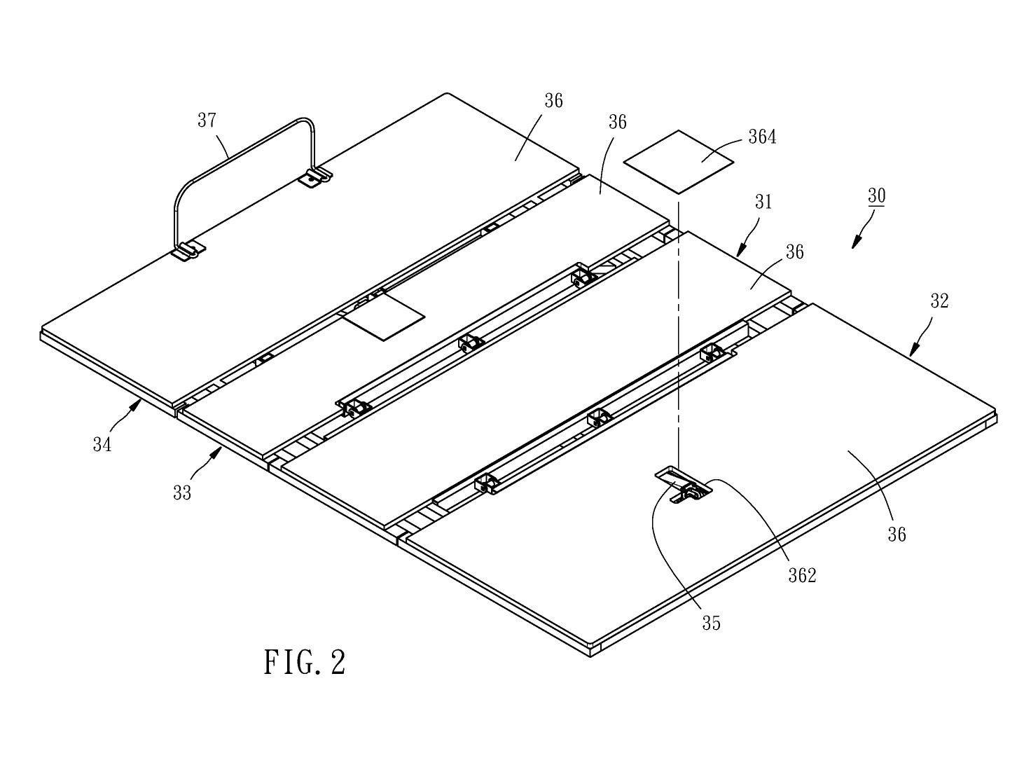

Referring to FIGS. 2 to 4, the electric bed frame 30 includes a fixed rack 31, a movable rack 32, a thigh rack 33, a shank rack 34, an actuator 35, four supporting boards 36, and a bracket 37. The electric bed frame 30 is adapted for a mattress (not shown) to be placed thereon.

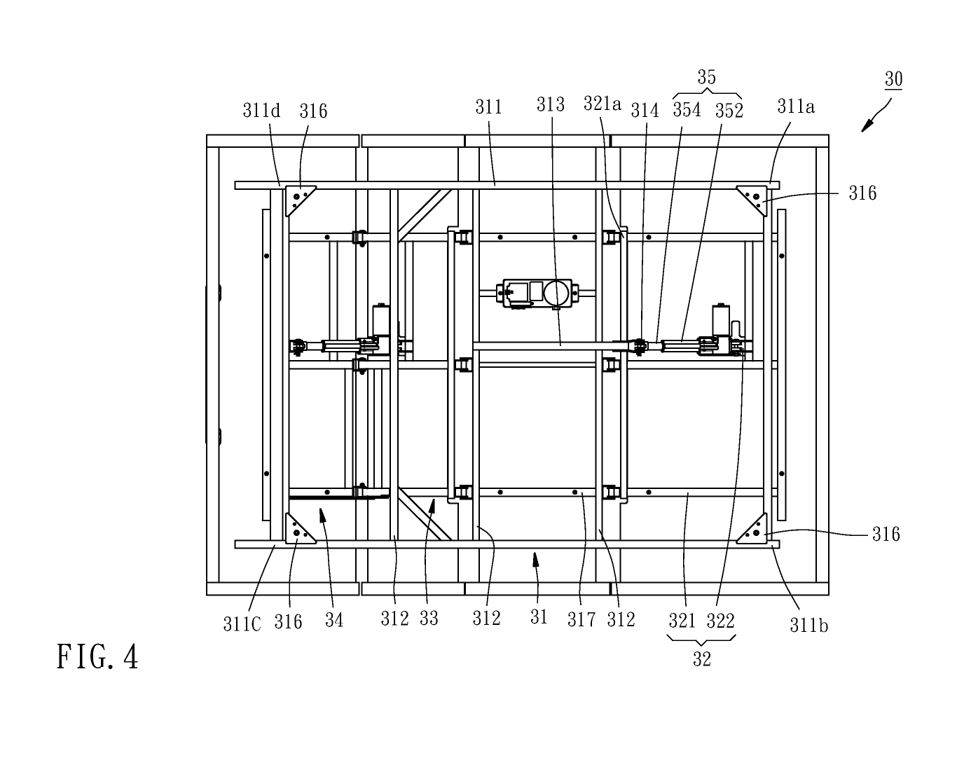

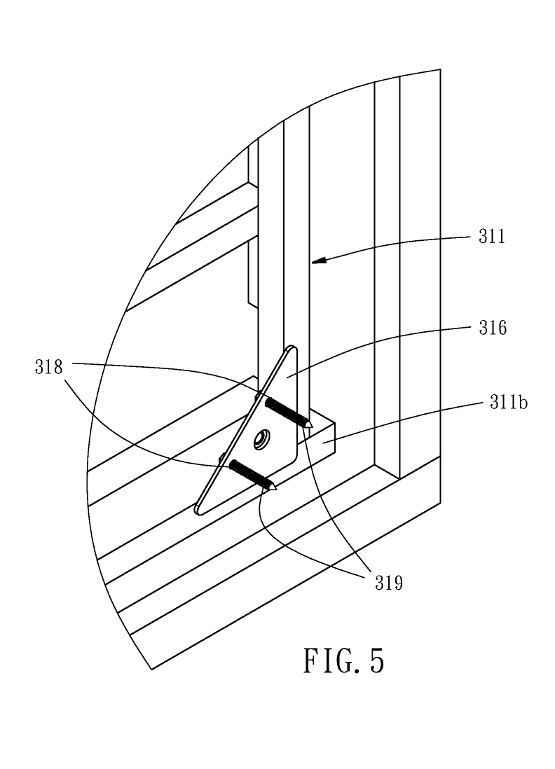

The directions would be defined according to the view of FIG. 4 in the following, the fixed rack 31 is located at the bottom of the supporting boards 36, and includes a rectangular frame 311, three connecting rods 312 in which two ends thereof are connected with the rectangular frame 311, a longitudinal rod 313 vertical to and connected with two of the connecting rods 312 on the right, a connecting portion 314 extended rightwardly from the right end 313a of the longitudinal rod 313, four corner plates 316 disposed at four corners 311a-311d of the rectangular frame 311 respectively, and a hip rack 317 disposed above two of the connecting rods 312 on the right. In this embodiment, each of the corner plates 316 has two through holes 318 as shown in FIG. 5 for being inserted through by two screw members 319, so that the screw members 319 are screwingly threaded to the platform 20, and the electric bed frame 30 would be combined with the bed platform 20.

It should be noticed that, the through holes 318 can be disposed at any location of the fixed rack 31, and the number of the through holes 318 can be modified based on that the electric bed frame 30 can be fixed on the bed platform 20. The electric bed frame 30 can be fixed on the bed platform 20 by gluing, welding, riveting, screwing, pinning, or other fixing techniques. In addition, the structure of the fixed rack 31 can be modified, for example, forming a mesh-shaped frame, adding more corner plates 316, and etc. In other embodiments, the bed platform 20 may be eliminated at the inside 141 of the car cabin 14, and the electric bed frame 30 can be fixed on a floor of the car cabin 14 or other locations.

The movable rack 32 has a frame 321 whose left end 321a is rotatably connected with the fixed rack 31 and a connecting portion 322 disposed at the frame 321. The movable rack 32 is swingable relative to the fixed rack 31. In this embodiment, the movable rack 32 is located correspondingly to the back of the user.

The thigh rack 33 is located above the frame 311, rotatably mounted on the hip rack 317, and swingable relative to the fixed rack 32. The shank rack 34 is located above the frame 311, rotatably mounted on the thigh rack 33, and swingable relative to the thigh rack 33. In other embodiments, the thigh rack 33 and the shank rack 34 may keep stationary.

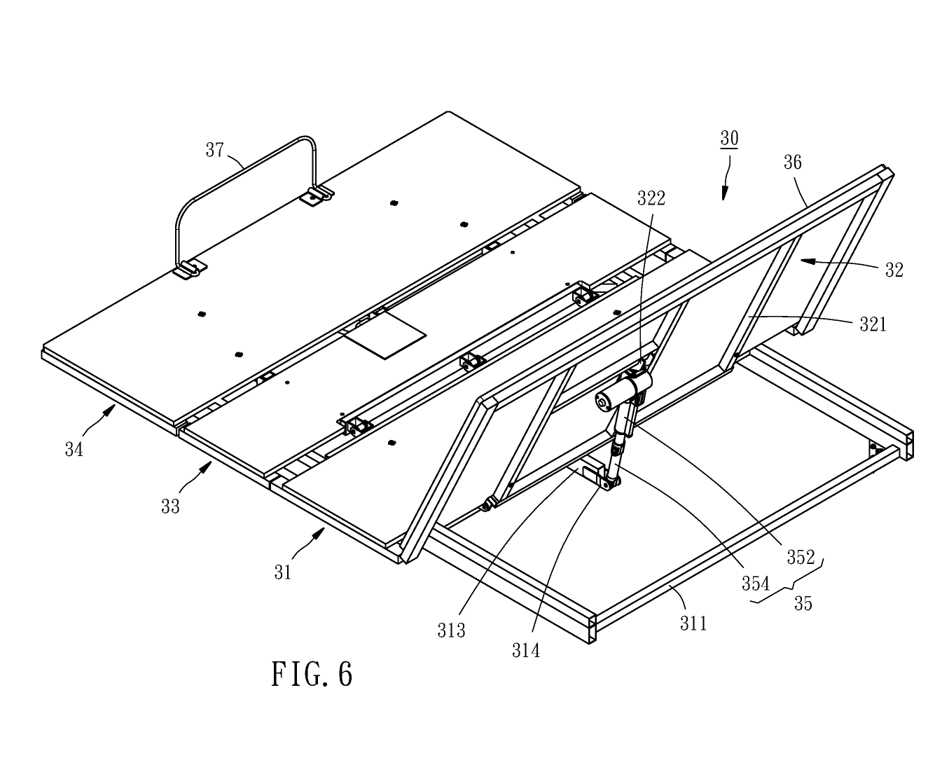

The actuator 35, two ends of which are rotatably connected with the fixed rack 31 and the movable rack 32 respectively, includes a cylinder 352 and a push lever 354 extended from the cylinder 352 and movable into and out of the cylinder 352. In this embodiment, the cylinder 352 of the actuator 35 is rotatably connected with the connecting portion 322 of the movable rack 32, and the push lever 354 of the actuator 35 is rotatably connected with the connecting portion 314 of the fixed rack 31. When the push lever 354 is moved out of the cylinder 352 to make the actuator 35 lengthened, the actuator 35 drives the movable rack 32 to swing upwardly relative to the fixed rack 31, as shown in FIG. 6. The movable rack 32 stops swinging upwardly when the push lever 354 is extended from the cylinder 352 for the longest length. When the push lever 354 is moved into the cylinder 352 to make the actuator 35 shortened, the actuator 35 drives the movable rack 32 to swing downwardly relative to the fixed rack 31. Eventually, the movable rack 32 stops swinging downwardly when the movable rack 32 is located as shown in FIG. 2.

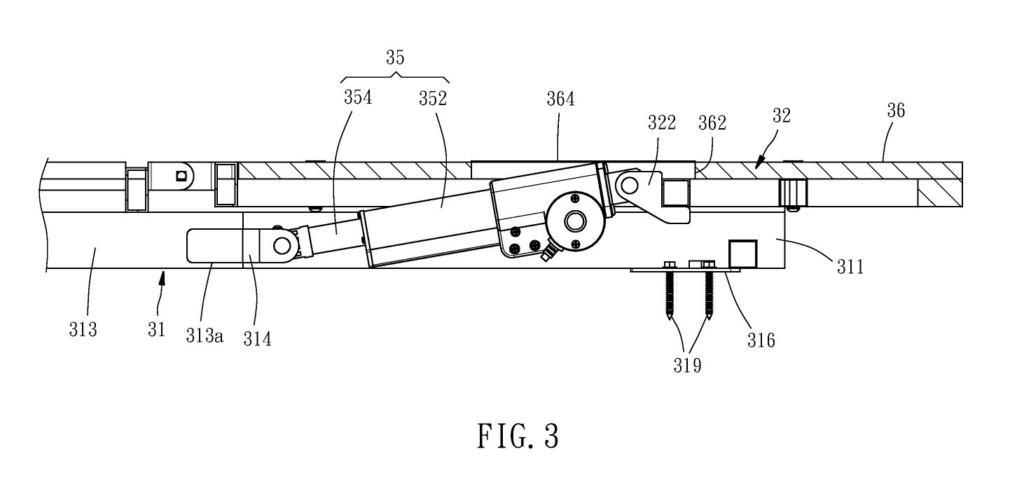

The four supporting boards 36 are disposed on the hip rack 317 of the fixed rack 31, the movable rack 32, the thigh rack 33 and the shank rack 34 respectively. The supporting board 36 disposed on the top side of the movable rack 32 is penetrated with a hollow portion 362 which accommodates a part of the actuator 35 and a part of the connecting portion 322 of the movable rack 32. In this embodiment, the cylinder 352 of the actuator 35 is partially accommodated in the hollow portion 362. Besides, it can be observed in FIG. 3 that the actuator 35 and the connecting portion 322 are not protruded out of the hollow portion 362. In addition, there is a cover plate 364 disposed at the top side of the hollow portion 362. The cover plate 364 can cover the whole hollow portion 362, or can be eliminated in other embodiments.

The bracket 37 is disposed on the supporting board 36 located at the foot portion of the bed for preventing the mattress from displacing. In this embodiment, the aforesaid supporting board 36 where the bracket 37 is disposed is located at the top side of the shank rack 34. In other embodiments, the bracket 37 may be disposed on other supporting boards 36, and the electric bed frame 30 may even include two or more brackets 37.

In fact, the supporting boards 36 are so thick to have enough structural strength to bear the weights of the mattress and the user, so the hollow portion 362 has enough space to accommodate parts of the actuator 35 and the connecting portion 322. Because there is the hollow portion 362, the position where the actuator 35 and the connecting portion 322 are rotatably connected with each other can be raised to provide the actuator 35 enough height difference between two ends thereof, so that the actuator 35 is long enough in lever arm for providing the torque to rotate the movable rack 32. As a result, the electric bed frame 30 can be lowered in thickness. When being used in coordination with the traditional bed, the quite thin electric bed frame 30 can lower the user's feeling of unfamiliarity. No matter the electric bed frame 30 is placed between the bed platform 20 and the mattress or between the floor of the car cabin 14 and the mattress, users can use a function of the electric bed frame 30 which is performing the lifting and lowering effect electrically in the camping car 1, and is convenient for the user to get on the bed and get off bed, thereby excellent in safety, convenience and comfortableness.

It should be noticed that, in other embodiments, the supporting board 36 may not have the hollow portion 362, and the location of the connecting portion 322 of the movable rack 32 can be modified accordingly.

Based on the spirit of the present invention, the structure of the electric bed frame 30 can be modified. For example, the actuator 35 can be installed in reverse direction, which means the push lever 354 of the actuator 35 is rotatably connected with the movable rack 32 and the cylinder 352 of the actuator 35 is rotatably connected with the fixed rack 31. However, in such condition the size and the shape of the hollow portion 362 should be modified correspondingly. Alternately, the connecting portion 322 of the movable rack 32 may not be accommodated in the hollow portion 362. In the aforesaid embodiment, the movable rack 32 is the back rack of the electric bed frame 30. However, the structural features of the present invention can be applied to the thigh rack 33 or the shank rack 34, which means the movable rack 32 defined in the present invention may be the thigh rack 33 or the shank rack 34 of the electric bed frame 30.

The above description represents merely the preferred embodiment of the present invention, without any intention to limit the scope of the present invention. The simple variations and modifications not to be regarded as a departure from the spirit of the invention are intended to be included within the scope of the following claims.

What is claimed is:

1. A camping car comprising:
a car body; and
an electric bed frame disposed inside the car body.

2. The camping car as claimed in claim 1, wherein the electric bed frame comprises:
a fixed rack;
a movable rack rotatably connected with the fixed rack;
an actuator, two ends of which are rotatably connected with the fixed rack and the movable rack respectively, the actuator comprising a cylinder and a push lever extended from the cylinder and movable into and out of the cylinder, the movable rack being swung upwardly relative to the fixed rack when the push lever is moved out of the cylinder to make the actuator lengthened, the movable rack being swung downwardly relative to the fixed rack when the push lever is moved into the cylinder to make the actuator shortened; and
a supporting board disposed on a top side of the movable rack.

3. The camping as claimed in claim 2, wherein the cylinder of the actuator is rotatably connected with the movable rack, and the push lever of the actuator is rotatably connected with the fixed rack.

4. The camping car as claimed in claim 2, wherein the push lever of the actuator is rotatably connected with the movable rack, and the cylinder of the actuator is rotatably connected with the fixed rack.

5. The camping car as claimed in claim 2, further comprising a bed platform disposed inside the car body; the electric bed frame is disposed on the bed platform.

6. The camping car as claimed in claim 5, wherein the fixed rack of the electric bed frame has a plurality of through holes, and the electric bed frame is combined with the bed platform by a plurality of screw members inserted through the through holes and screwingly threaded to the bed platform.

7. The camping car as claimed in claim 6, wherein the fixed rack of the electric bed frame has a rectangular frame and four corner plates respectively disposed at four corners of the rectangular frame, and each of the corner plates has at least one of the through holes.

8. The camping car as claimed in claim 2, wherein the supporting board has a hollow portion accommodating a part of the actuator.

9. The camping car as claimed in claim 8, wherein the movable rack has a connecting portion rotatably connected with one of the two ends of the actuator and partially located in the hollow portion of the supporting board.
